(19) United States
(12) Patent Application Publication
(10) Pub. No.: US 2023/0132614 A1
(43) Pub. Date: May 4, 2023

(54) ELECTROMAGNETIC ASSEMBLIES FOR PROCESSING FLUIDS

(71) Applicant: Beckman Coulter, Inc., Brea, CA (US)

(72) Inventors: Jeffrey J. Corpstein, Noblesville, IN (US); Evan Farthing, Indianapolis, IN (US); Thomas G. Keen, Indianapolis, IN (US); Abraham Olson, Brea, CA (US); Andrew Horton, Indianapolis, IN (US); Kerry J. Weaver, Indianapolis, IN (US); Roger A. Wyman, Indianapolis, IN (US)

(73) Assignee: Beckman Coulter, Inc., Brea, CA (US)

(21) Appl. No.: 17/916,634

(22) PCT Filed: Apr. 2, 2021
(86) PCT No.: PCT/US2021/025587

§ 371 Date: Oct. 3, 2022

Related U.S. Application Data
(60) Provisional application No. 63/004,913, filed on Apr. 3, 2020.

(51) Int. Cl. B01L 3/00; B03C 1/28; B03C 1/033; B03C 1/01

(52) U.S. Cl. CPC B01L 3/502761; B03C 1/288; B03C 1/0335; B03C 1/01; B01L 2200/0668; B01L 2300/0645; B01L 2400/043; B03C 2201/18; B03C 2201/22; B03C 2201/26

(57) ABSTRACT

The disclosure relates to methods and apparatus for processing fluids through the use of a magnetic assembly wherein the magnetic assembly includes at least one fluid chamber containing a fluid and magnetic particles.

### CLAIM OF PRIORITY

This patent application is a national stage application of PCT/US2021/025587, filed Apr. 2, 2021, which claims the benefit of priority to U.S. Provisional Application Ser. No. 63/004,913, filed Apr. 3, 2020, which is incorporated by reference herein in its entirety.

### BACKGROUND

The preparation of samples is a critical phase of chemical and biological analytical studies. In order to achieve precise and reliable analyses, target compounds must be processed from complex, raw samples and delivered to analytical equipment. For example, proteomic studies generally focus on a single protein or a group of proteins. Accordingly, biological samples are processed to isolate a target protein from the other cellular material in the sample. Additional processing is often required, such as protein isolation (e.g., immunoprecipitation), matrix cleanup, digestion, desalting. Non-target substances such as salts, buffers, detergents, proteins, enzymes, and other compounds are typically found in chemical and biological samples. These non-target substances can interfere with an analysis, for example, by causing a reduction in the amount of target signal detected by analytical equipment. As such, complex, raw samples are typically subjected to one or more separation and/or extraction techniques to isolate compounds of interest from non-target substances.

Magnetic particles or beads are a technology that can be employed for sample preparation for chemical and biological assays and diagnostics. One key element in magnetic particle separation and handling technology is efficient mixing to enhance the reaction rate between the target substances and the particle surfaces, the mass transfer from one substrate to another or the transfer of an analyte from one medium to another.

One known technique for mixing fluids using magnetic particles, involves moving a magnet relative to a stationary container or moving the container relative to a stationary magnet using mechanical means to induce relative displacement of a magnetic field gradient within the container. Another technique involves the use of two electromagnets facing each other around a chamber having magnetic particles arranged therein. Sequentially energizing and de-energizing the two electromagnets (i.e., binary on/off control) at a sufficient frequency operates to suspend the magnetic particles within a fluid disposed in the chamber. Such techniques may require excessive power consumption and could cause magnetic particles to separate slowly. Or such techniques could require modified lens arrangements which could reduce mixing quality. But these and other techniques known in the art suffer from various drawbacks, including the aggregation of particles and inefficiency in mixing of the particles. Further, such techniques may require manual intervention between stages of the process. A technique to improve mixing solutions using magnetic beads is the use of electromagnets surrounding a sample container to create a changing magnetic field.

However, magnetic particles typically used for capture and isolation of biological molecules are paramagnetic. Paramagnetic beads are responsive to an applied external magnetic field but retain little or no residual magnetism when that field is removed. This low residual magnetism reduces or eliminates clumping of the beads, allowing the beads to remain dispersed and suspended in solution and to be easily transferred through a pipette tip. Paramagnetic beads, however, are generally less responsive to an external magnetic field and therefore are more difficult to effectively mix using an electromagnetic mixer, particularly in viscous solutions such as those used to selectively precipitate and isolate nucleic acids using magnetic beads. Accordingly, a need exists to provide an arrangement of electromagnetic elements that more effectively induces efficient mixing of such magnetic particles.

### SUMMARY

Apparatus, systems, and methods are described herein allow for the processing of sampling devices and fluids using electromagnetic assemblies without the limitations of known techniques. For example, the apparatus, systems, and methods described herein allow for the processing of sampling devices and fluids using electromagnetic assemblies on sample volume without sample loss or magnetic particle loss.

### DESCRIPTION OF THE DRAWINGS

A description is provided herein below with reference, by way of example, to the following drawings. It will be understood that the drawings are provided as examples only and that all reference to the drawings is made for the purpose of illustration only and are not intended to limit the scope of the disclosure in any way. For convenience, reference numerals can also be repeated (with or without an offset) throughout the figures to indicate analogous components or features.

FIGS. 1A-1D are schematics of fluid processing systems according to various aspects described herein.

FIGS. 2A and 2B are schematics illustrative open-well magnetic sample plate according to various aspects described herein.

FIG. 3 is a schematic illustrative fluid processing system according to various aspects described herein.

FIG. 4 is a schematic illustrative fluid processing structure and mixing pattern thereof according to various aspects described herein.

FIG. 5 is a schematic illustrative fluid processing structure and mixing patterns thereof according to various aspects described herein.

FIG. 6 is a schematic illustrative fluid processing and analysis system according to various aspects described herein.

FIGS. 7A-B is a schematic of another example of a fluid processing system according to various aspects described herein.

FIG. 8 is a representation of one example of the z-direction mixing resulting from the physical movement of the magnetic lenses described herein.

FIGS. 9A-B are representation fluid processing systems according to various aspects described herein.

FIG. 10A-B is a representation of a 4-point lens shape.

FIG. 11 is a representation of an illustrative lens shape.

FIG. 12 is a picture of an example magnetic lens assembly where the lenses are fastened to the electromagnet core via a threaded nut.

FIG. 13A-C is a representation of a permanent magnet rails where such rail component moves in and out of the array of tubes for separation.

FIGS. 14A-B are representations of moving the sample tube 115 relative to magnetic lenses 730b (FIG. 14A) created by a collection of lens members 730c and moving the entire magnetic assembly 900 relative to the sample tube 115 (FIG. 14B).

FIG. 15 is a representation of one example of an assembly of vertically oriented permanent magnets which may be reversibly positioned adjacent to the fluid sample.

### DESCRIPTION

Those skilled in the art will understand the methods, systems, and apparatus described herein are non-limiting examples and the scope of the applicant's disclosure is defined solely by the claims. While the applicant's teachings are described in conjunction with various aspects, it is not intended for the applicant's teachings be limited to such aspects. On the contrary, applicant's teachings encompass various alternatives, modifications, and equivalents, as will be appreciated by those of skill in the art. The features illustrated or described in connection with one example can be combined with the features of other aspects. Such modifications and variations are intended to be included within the scope of the applicant's disclosure.

The disclosure generally relates to fluid processing methods and systems for mixing, separating, filtering, or otherwise processing a fluid sample by utilizing magnetic particles dispersed therein. In accordance with various aspects of the disclosure, the fluid sample can be disposed within a fluid chamber. In accordance with various aspects, the fluid could also be a viscous solution; however, the word fluid will be generally used to describe any material in which the sample can be suspended. A plurality of fluid chambers are held and dispersed throughout a fluid container. The fluid chamber can be an open tube or similar device (e.g., open to the atmosphere) such that the sample and/or reagents can be directly added to the open fluid chamber (e.g., via an auto-sampler or pipette inserted through the open end of the fluid chamber) and can likewise be directly removed therefrom (e.g., via a capture device) following the processing, for example.

The magnetic particles, disposed and dispersed within the fluid, can be configured to be agitated under the effect of magnetic fields (or gradients) generated by a magnetic assembly arranged adjacent to the fluid chambers (e.g., arranged about the periphery of the fluid container) so as to facilitate the movement of the magnetic particles within the fluid. The magnetic assembly can include a one or a plurality of magnetic structures arranged in horizontal or substantially horizontal layers. Each of the magnetic structures can be formed by one or more magnets, such as an electromagnet. The vertical position of one or more of the magnetic structures, relative to the fluid, can be movable or adjustable, for instance, before, during, or after facilitating the movement of the magnetic particles within the fluid. Adjustment of the vertical position of the one or more of the magnetic structures before facilitating movement of the magnetic particles can be used, for example, to process different sample volumes and/or to affect a characteristic of a magnetic field generated by the magnetic assembly. Vertical movement of the magnetic structures while facilitating the movement of the magnetic particles may add, for example, a vertical component of movement in the particles to provide a more effective or efficient mixing of the particles in the fluid. Additionally or alternatively, the electrodes of the various magnetic structures (e.g., of the different vertically-spaced layers) can be selectively energized so as to process different sample volumes and/or to affect a characteristic of a magnetic field generated by the magnetic assembly.

The magnetic assembly structures can be formed from a plurality of electromagnets disposed around the fluid chamber at one or more different vertical heights, with each electromagnet being individually controlled to generate a desired magnetic field within the fluid chamber effective to influence the magnetic particles disposed therein. Based on the selective application of electrical signals to the plurality of electromagnets surrounding the fluid chamber, the magnetic particles can be influenced to rotate, spin, move horizontally side-to-side, and/or vertically up-and-down, or any combination of such movements, within the fluid sample by the combined effect of the magnetic field gradients generated by the various electromagnets. By way of example, the signals applied to the electromagnets of each magnetic structure (e.g., in a single horizontal layer) can be configured to generate magnetic field gradients substantially in the x-y plane, while the signals applied to the electromagnets of the different magnetic structures, if present (e.g., the electromagnets in different horizontal layers) can result in magnetic field gradients exhibiting a z-direction or vertical component. In this manner, the combined effect of the plurality of electromagnets can produce a magnetic field within a sample container with different characteristics, such as different strengths and/or directionality so as to rapidly and efficiently mix the fluid and/or capture target analytes within the fluid, by way of non-limiting example.

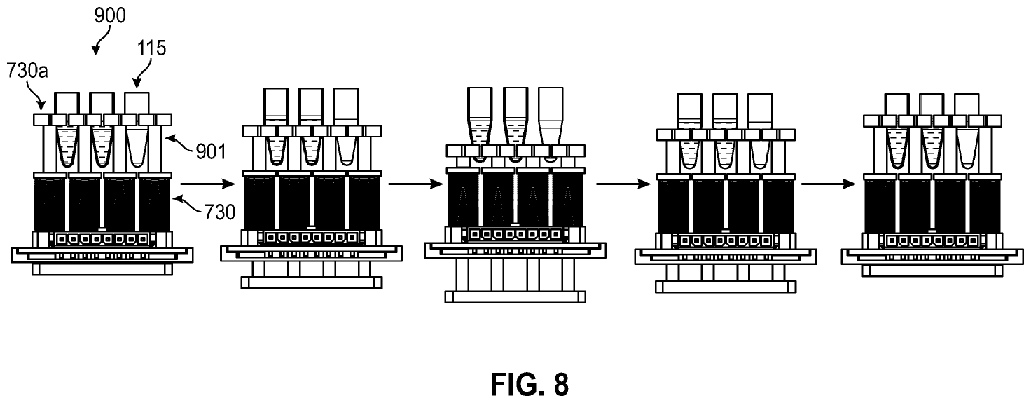

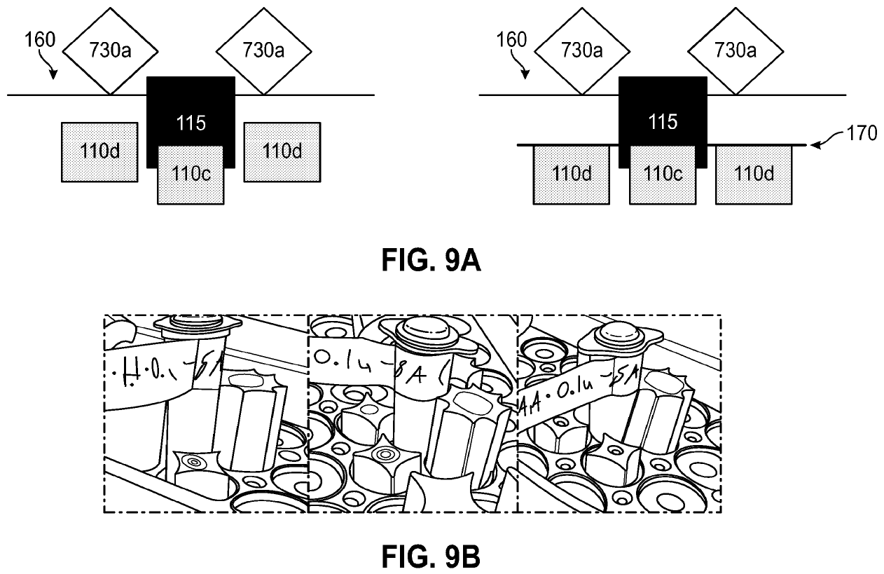

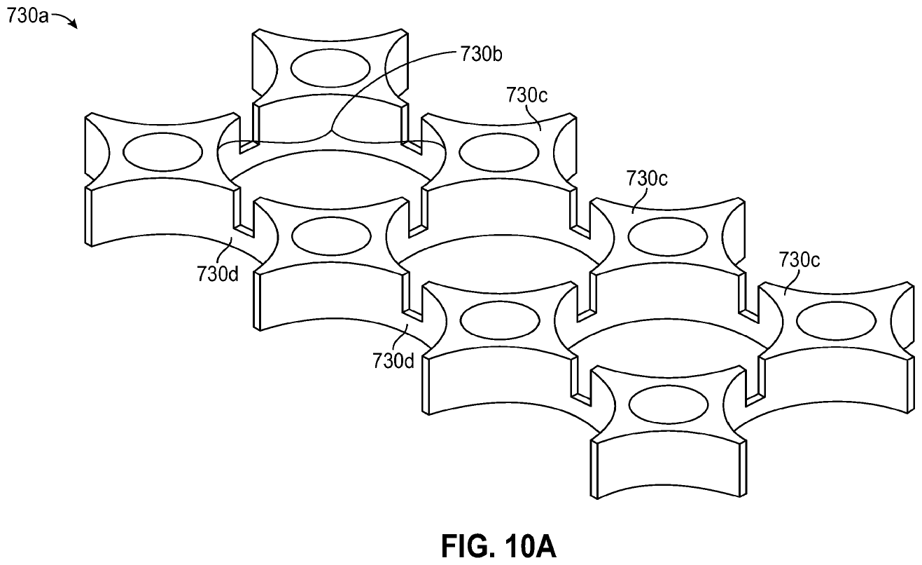

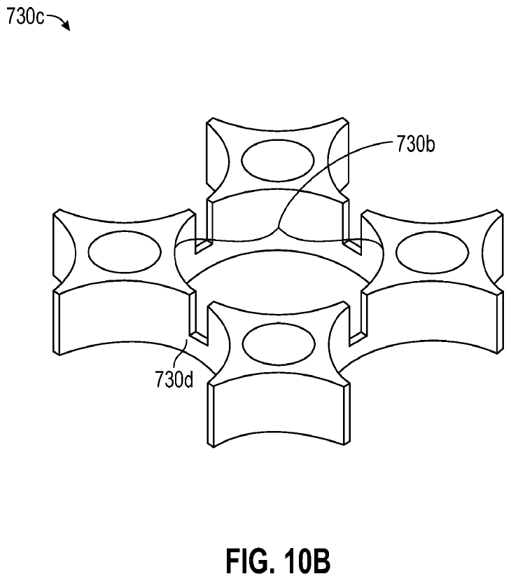

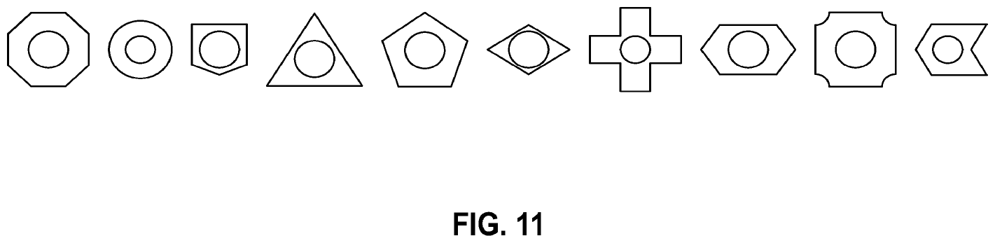

Making reference to FIG. 8, an assembly 900 comprising a pin 901 made of a magnetically permeable metal is placed through the center of a coil 730, the pin 901 extending above the coil 730. When the coil 730 is actuated, it creates a magnetic field that is transmitted to pin 901 and, in turn, to lens assembly 730a, which is also made of a magnetically permeable metal. Lens assembly 730a comprises a plurality of magnetic lenses 730b (see FIG. 10A) created by a collection of lens members 730c, each focusing and shaping the magnetic field in a desired area, in this example within sample tube 115 comprising magnetic particles (not shown). The lens members 730c comprised in assembly 730a can have any suitable shape. In various examples, the lens member 730c can have a circular shape. In various examples, the lens member 730c has a 4-point shape, such as the one shown in FIG. 10B. By further example, the lens member could be formed in any shape most efficient to the assembly such as those show in FIG. 11. In various aspects, the magnetic lens is brought into contact (or very close to) the samples described herein, such as a sample tube 115.

In various examples, the lenses are 0.25 mm thick to 20 mm thick. In another example, the lenses are 2 mm thick to 12 mm thick.

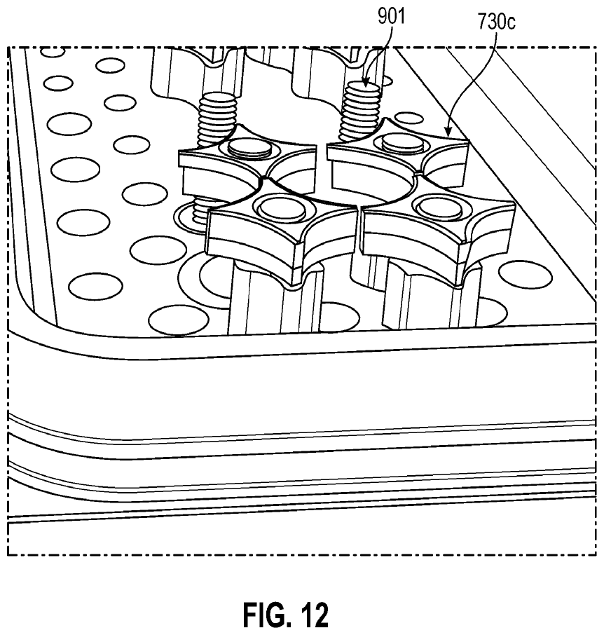

Although the lens assemblies shown in FIG. 10A and 10B are substantially unitary because each lens member 730c is joined by linking members 730d, in various examples, one or more of the plurality of lens members 730c can be individual. See for example FIG. 12, where each individual lens member 730c comprises threads configured to accept and thread on to threaded pin 901. In various aspects, the magnetic lenses are formed of a single lens member 730c and a plurality of the lens members 730c would make up lens assembly 730a.

In various examples, the coils used to induce the magnetic field are encased in aluminum or copper. In various examples, the array of electromagnetic coils is completely encased in a block of aluminum, or other highly thermally conductive material with low magnetic permeability. In addition, a small amount of thermal potting compound (not shown) can be placed between the block and the coil to create full contact between the coils and block. In various aspects, the coils 730 and lens assembly 730a are encased in a solid potting material (not shown).

In various examples, the heat from the coils is isolated from the samples and removed from the device in order to maintain a suitable temperature of the sample.

In various examples, the samples can be heated or cooled such that they are maintained or thermocycled at a different temperature than ambient. The heating or cooling can be accomplished using any suitable heating or cooling element. In one example, the samples can be heated using the heat generated by the coils used to induce the magnetic fields.

The lens assembly can be moved relative to the sample tube, while one or more of the coils are actuated, in order to move the beads up and down through the sample liquid. The lens assembly can be physically moved while the sample tube remains stationary. The sample tube can be physically moved while the lens assembly remains stationary. Both the lens assembly and the sample tube can be physically moved. In various examples, the lens magnetic assemblies and/or structures cause particles (e.g., ferrimagnetic particles) to spin, or travel back and forth in x-, y-, and z-directions as confined by the presence of the magnetic fields. By way of example, the signals applied to the electromagnets 110a-d of each magnetic structure 110 (e.g., in a single horizontal layer) can be configured to generate changing magnetic fields substantially in the x-y plane, while the movement of the lens assembly relative to the sample tube creates a changing field in a z-direction or vertical component of mixing. In this manner, the combined effect of the plurality of electromagnets can produce a magnetic field within the container 115 with different characteristics, such as different strengths and/or directionality so as to rapidly and efficiently mix the sample and/or capture target analytes within the sample, by way of non-limiting example. The vertical movement of the lens assembly or sample tube can be a single motion upward or downward or may include any combination of upward and downward movements in succession. The vertical movement can begin at any vertical position of the lens assembly relative to the sample tube. In some aspects, upward vertical movement can begin when the lens assembly is positioned near the bottom of the sample tube in order to induce vertical resuspension of magnetic particles that may have settled toward the bottom of the tube. In some examples, vertical movement of the lens assembly or sample tube can begin when the lens assembly is positioned near a sedimentation or boundary layer between liquids or components that can be separating in the sample fluid. In this way, the vertical movement of the lens assembly or sample tube, while the coils are actuated, can help disrupt this sedimentation or boundary layer to provide more effective mixing of the entire sample fluid. The rate of vertical movement can be any suitable rate that maintains effective mixing in the x-y plane while providing sufficient distribution of mixing along the z-direction. The range of the vertical motion can be any suitable range required to maintain sufficient mixing along the z-direction.

In various examples, the controller can be configured to differentially actuate the electromagnets via the application of one or more of radio frequency (RF) signals, direct current (DC) signals, alternating current (AC) signals, electro frequency (EF), or the like, and also including any combination thereof. In various examples, the RF signals applied to the plurality of electromagnets can exhibit different phase delays relative to one another so as to effect the desired movement of the electromagnets within the sample fluid. In some aspects, the DC signals can be effective to isolate the particles (e.g., draw magnetic particles to one side and/or vertical level of the fluid chamber) such that fluid can be withdrawn from the chamber without aspiration of the magnetic particles, by way of non-limiting example. In some examples, a constant-voltage DC signal can be interspersed between alternating or changing actuating signals in order to provide more effective mixing of the sample fluid. The alternating or changing actuating signals surrounding the constant-voltage DC signal can be any suitable RF, AC, DC, or EF signal, or the like.

In various examples, the tube is to remain nonrotatable during the mixing process. For example, the tube can be mechanically fixed in place with an interference fit mechanism. The tube can also be screwed or similarly rotated into a locked position within the rack. The tube can also be held in a nonrotatable manner by use of lid or similar feature associated with the rack.

Fluid processing systems described according to various examples can be configured to process fluids at the micro-scale or macro-scale (including large-volume formats). In general, the macro-scale involves fluid volumes in the milliliter range, while micro-scale fluid processing involves fluid volumes below the milliliter range, such as microliters, picoliters, or nanoliters. Large-volume formats can involve the processing of fluid volumes greater than 1 mL. For example, fluid processing systems in accordance with various aspects of the present teaching can be capable of processing a fluid volume of about 1 μL. to about 15 mL and even greater, including for example, about 1.5 mL, about 2 mL, about 5 mL, about 10 mL, or greater. In some aspects, the fluid chamber is configured to hold a volume in a range of about 20-200 μL.

In some examples, the fluid chamber is configured to extend from a lower, closed end to an upper, open end that is configured to be open to the atmosphere to receive the fluid to be processed therethrough. In some examples, the fluid chamber comprises a lid.

However, it will be appreciated in light of the disclosure that the fluid processing systems can process any fluid volume capable of operating as described herein.

The use of magnetic assemblies to influence magnetic particles according to various examples, for instance, as compared to conventional magnetic particle processing systems, can provide multiple technological advantages. One non-limiting example of such an advantage includes significantly improved rates of diffusion for increased sample contact rate in various volumes of the sample fluid, for example, to improve analyte capture efficiency in a magnetic immunoassay. Another non-limiting example of a technological advantage includes increased sample mixing efficiency as the magnetic structures of a magnetic assembly can influence the magnetic particles to provide for faster and more effective sample mixing due to, for example, more robust magnetic particle movement and movement in multiple dimensions. This can, for example, lead to increased mass transfer between components.

Processing samples using the fluid processing structures configured according to applicant's teachings generates fast reaction kinetics. For instance, protein processing (including immunological affinity pull-down, washing, elution/denaturation, reduction, alkylation, and digestion steps) can be completed in about 10-12 minutes, compared with a one- or two-day processing time for manual, in-tube processing. The increased processing speed can be achieved, for example, due to overcoming diffusion as a rate-limiting step of fluid processing (e.g., a rate-limiting step of LC) and the necessity of utilizing small, fixed volumes in known microfluidic platforms. In addition, such fast, efficient sample processing can be achieved across a large array of sample reaction containers simultaneously as the fluid processing structures configured according to applicant's teachings can be integrated into large arrays of sample reaction wells, thereby increasing sample processing and enabling automation via an autosampler, for example. It will be appreciated in light of the disclosure that the fluid processing systems described herein provide multiple other technological advantages in addition to the aforementioned non-limiting examples.

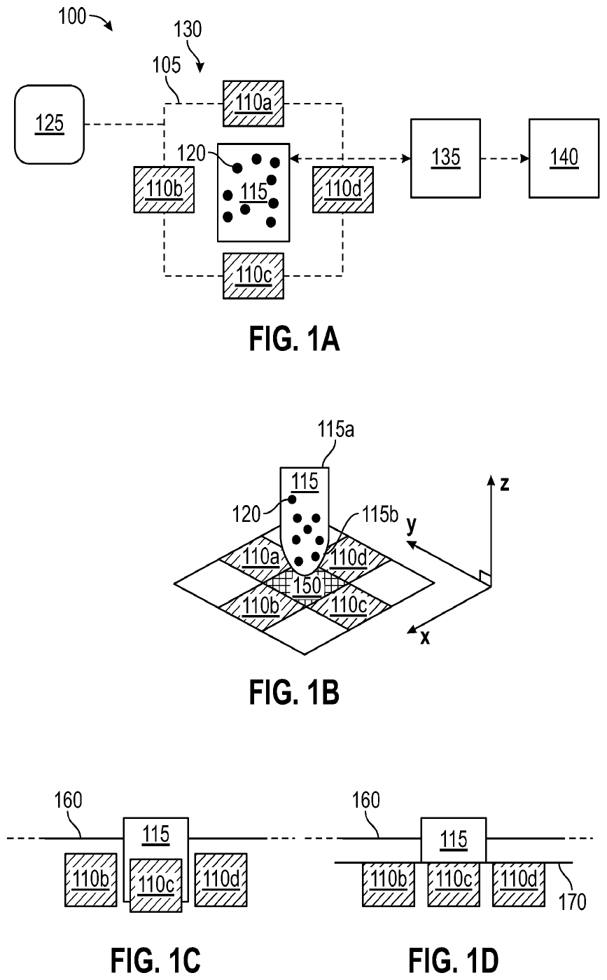

While the systems, devices, and methods described herein can be used in conjunction with many different fluid processing systems, an example of a suitable fluid processing system 100 is illustrated schematically in FIG. 1A. It should be understood that the fluid processing system 100 represents only one possible fluid processing system for use in accordance with systems, devices, and methods described herein, and fluid processing systems and/or components thereof having other configurations and operational characteristics can all be used in accordance with the systems, devices, and methods described herein as well.

In various aspects, in solutions where a sample has been added to a more viscous bead-containing solution, the two liquids may partially separate, forming at least one boundary between partially-separated liquid layers. Vertical movement of a magnetic assembly near or across such a boundary, while actuating one or more electromagnets of the assembly to mix the combined sample and bead solution, may provide more effective or thorough mixing of the combined sample and bead solution. In some examples, the vertical position of the boundary can be pre-estimated based on known volumes of the bead-containing solution and the added sample. In other examples, the vertical movement of the magnetic assembly is programmed to encompass a majority or a totality of the range of the sample fluid or sample tube in order to facilitate effective mixing regardless of the initial vertical position of the boundary.

FIG. 1A schematically depicts an example of a fluid processing system 100. As shown in FIG. 1A, the fluid processing system 100 includes a fluid processing structure or container 130 having a fluid chamber 115 and a magnetic structure 105 configured to generate a magnetic field gradient or magnetic force within the fluid chamber, as discussed in detail below. The fluid chamber 115 can generally comprise any type of vessel configured to hold a sample fluid, such as a sample well, a vial, a fluid reservoir, or the like, defining a fluid-containing chamber therein. As best shown in FIG. 1B, the fluid chamber 115 extends from an open, upper end 115a (open to the ambient atmosphere) to a lower, closed end 115b such that the fluid within the fluid chamber 115 can be loaded and/or removed therefrom by one or more liquid loading/collection devices 135 that can be inserted into the open, upper end 115a. It will be appreciated by those skilled in the art that the chamber 115 can include a removable cap that can be coupled to the open, upper end 115a (e.g., an Eppendorf tube) during various processing steps, for example, to prevent the escape of fluid during mixing, contamination, and/or evaporation. Illustrative liquid loading/collection devices 135 can include, without limitation, manual sample loading devices (e.g., pipette), multi-channel pipette devices, acoustic liquid handling devices, and/or an auto-sampler, all by way of non-limiting example.

With reference again to FIG. 1A, the sample fluid can have a plurality of magnetic particles 120 disposed therein and that can be added to the sample fluid before transferring the sample fluid to the fluid chamber 115, or can be added to the fluid chamber 115 before or after the sample fluid has been transferred thereto.

Suitable magnetic particles 120 for use in the systems and methods described herein include, but are not limited to paramagnetic particles, such as AMPure XP beads available from Beckman Coulter, Inc., Brea, CA. Suitable magnetic particles also include those described in U.S. Pat. Nos. 5,705,628; 5,898,071; and 6,534,262, and in Published PCT Appl. No. WO 2020/018919, published Jan. 23, 2020, all of which are incorporated by reference as if fully set forth herein.

As used herein, “ferrimagnetic particles” refers to particles comprising a ferrimagnetic material. Ferrimagnetic particles can respond to an external magnetic field (e.g., a changing magnetic field), but can demagnetize when the external magnetic field is removed. Thus, the ferrimagnetic particles are efficiently mixed through a sample by external magnetic fields as well as efficiently separated from a sample using a magnet or electromagnet but can remain suspended without magnetically induced aggregation occurring.

The magnetic particles 120 described herein are sufficiently responsive to magnetic fields such that they can be efficiently moved through a sample. In general, the range of the field intensity could be the same range as any electromagnet as long as it is able to move the particles. For example, the magnetic field has an intensity of between about 10 mT and about 250 mT, between about 20 mT and about 80 mT, and between about 30 mT and about 50 mT. In some examples, more powerful electromagnets can be used to mix less responsive microparticles. In some examples, the magnetic field can be focused into the sample as much as possible. Also, the electromagnets can be as close to the sample as possible since the strength of the magnetic field decreases as the square of the distance.

The magnetic particles 120 can be a variety of shapes, which can be regular or irregular. In some examples, the shape maximizes the surface areas of the particles. For example, the magnetic particles 120 can be spherical, bar shaped, elliptical, or any other suitable shape. The magnetic particles 120 can be a variety of densities, which can be determined by the composition of the core. In some examples, the density of the magnetic particles can be adjusted with a coating.

The magnetic structure 105 can include a plurality of electromagnets 110a-d. Although four electromagnets 110a-d are depicted in FIG. 1A, the number and kind of magnets are not so limited as any number of electromagnets capable of operating according to various aspects of the applicant's teachings can be used. The four electromagnets 110a-d can operate the same as or substantially similar to a quadrupole magnet structure. For example, a magnetic structure 105 can include two electromagnets, three electromagnets, or four electromagnets 110a-d, as depicted in FIG. 1A; however, there can be more electromagnets as necessary. The electromagnets 110a-d can include any electromagnet known to those having skill in the art, including, for example, a ferromagnetic-core electromagnet. The electromagnets 110a-d may have various shapes, including square, rectangular, round, elliptical, or any other shape capable of operating according to various aspects of the applicant's teachings.

As shown in FIG. 1A, the fluid processing system 100 additionally includes a controller 125 operatively coupled to the magnetic structure 105 and configured to control the magnetic fields produced by the electromagnets 110a-d. In various aspects, the controller 125 can be configured to control one or more power sources (not shown) configured to supply an electrical signal to the plurality of electromagnets 110a-d. The electrical signal can be in the form of radio frequency (RF) waveforms, DC current, AC current, or the like. Although RF waveforms are generally used herein as an example of waveforms that can be applied to the electromagnets 110a-d to promote mixing of the fluid sample, the types of electrical signals are not so limited, as any type of electrical current capable of operating according to various aspects of applicant's teachings are contemplated herein. By way of example, a DC signal can additionally or alternatively be applied to one or more of the electromagnets so as to draw magnetic particles to one side of the fluid chamber. A further example may include a DC signal that can be supplied between RF and/or AC signals to facilitate mixing of the sample, or be supplied after RF and/or AC signals so as to aid in fluid transfer from the chamber after the mixing step and/or prevent the aspiration of the magnetic particles. In various examples, the controller 125 can be any type of device and/or electrical component capable of actuating an electromagnet. The controller 125 can operate to regulate the magnetic field produced by each of the electromagnets 110a-d by controlling the electrical current passing through a solenoid or coil of each of the electromagnets. The controller 125 can include or be coupled to a logic device (not shown) and/or a memory, such as a computing device configured to execute an application configured to provide instructions for controlling the electromagnets 110a-d. The application can provide instructions based on operator input and/or feedback from the fluid processing system 100. The application can include and/or the memory can be configured to store one or more sample processing protocols for execution by the controller 125.

In various aspects, each electromagnet 110a-d can be individually addressed and actuated by the controller 125. For example, the controller 125 can supply RF electrical signals of different phases to each of the one or more of the electromagnets 110a-d such that one or more of the electromagnets generate a different magnetic field. In this manner, the magnetic field gradient generated by the magnetic structure 105 within the fluid chamber 115 can be rapidly and effectively controlled to manipulate the movement of magnetic particles 120 within the sample fluid. The RF waveforms and the characteristics thereof (e.g., phase shifts) can be applied to the electromagnets 110a-d according to the sample processing protocol. It will be appreciated in light of the disclosure that the magnetic structures 105 can be utilized to manipulate the magnetic particles 120 within the sample fluid in various processes including, without limitation, protein assays, sample derivatization (e.g., steroid derivatization, sample derivatization for gas chromatography, etc.), and/or sample purification and desalting. Following this processing, processed fluid can be delivered to various analytical equipment 140, such as a mass spectrometer (MS) for analysis. A single layer of electromagnets 110a-d (e.g., arranged at a height above the bottom 115b of the fluid chamber about the periphery of the fluid container) can be actuated to generate a magnetic field within the fluid chamber 115 that captures and/or suspends the magnetic particles 120 in a particular plane within the fluid chamber. For example, the magnetic particles 120 can be suspended in a particular plane to move the magnetic particles away from the bottom of the fluid chamber during a fluid collection process and/or for processing fluids (e.g., reagents) in a plane above material (e.g., cells adhering to the lower surface of the fluid chamber), where contact with the material on the lower surface of the fluid chamber is to be avoided.

In accordance with various examples of the disclosure, the magnetic structures 105 can be incorporated into various fluid processing systems and fluid handling devices. With reference now to FIG. 1B, an example of a magnetic structure 105 is depicted as a standalone mixing device. For instance, a magnetic structure 105 can be used as the mixing element of a magnetic mixer or as a mixing element of a vortex-type mixer (i.e., replacing the motor-driven mixing element). The fluid chamber 115 (e.g., a single vial and/or a sample well of a sample plate) can be pressed against an actuator 150 to initiate the controller 125 to actuate the electromagnets 110a-d according to applicant's teachings. In other examples, magnetic structures 105 can be used for mixing magnetic particles 120 within the sample wells of a sample plate, such as a conventional 4, 8, 12, or 96 well sample plate. Magnetic structures 105 can be configured to mix magnetic particles 120 within the sample wells of open-well sample plate (i.e., open-to-atmosphere, sealed with a removable covering or cap, and/or partially enclosed). As shown in FIG. 1C, the fluid chamber 115 (i.e., sample well) of a sample plate 160 may fit down within a cavity formed between the electromagnets 110a-d. In another example, as shown in FIG. 1D, a sample plate 160 can be placed on a portion of the fluid processing system 100, such as on a planar surface 170 thereof, such that the sample well 115 can be arranged adjacent to the electromagnets 110a-d.

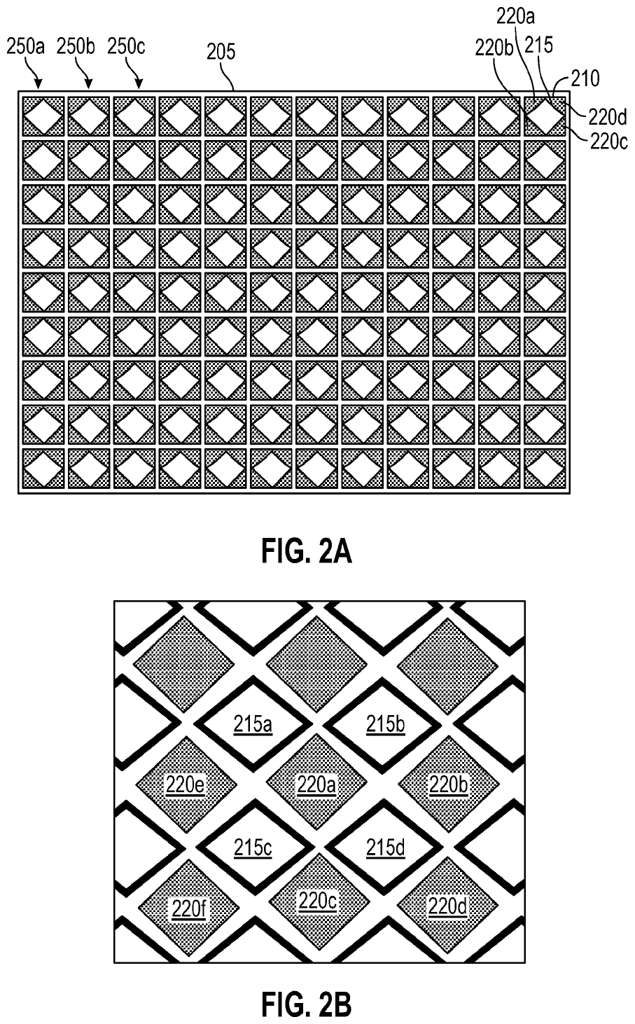

FIG. 2A depicts an example of an open-well magnetic sample plate. As shown in FIG. 2A, a 96-well sample plate 205 can include a plurality of sample wells 215. Although diamond-shaped sample wells 215 are depicted in FIG. 2A, it will be appreciated that the fluid chambers in accordance with the disclosure are not so limited. For instance, the sample wells 215 can have various shapes, including square, rectangular, round, elliptical, or any other shape capable of operating according to various examples of the applicant's teachings. Each sample well 215 can be surrounded about its periphery by a magnetic structure 210 that includes a plurality of electromagnets 220a-d. The magnetic structures 210 and the methods of mixing magnetic particles using RF-driven oscillating magnetic fields according to various aspects of the applicant's teachings can be incorporated into existing sample plate devices, including sample plate devices configured as large, open arrays of sample wells 215. For example, the magnetic structures 210 can be configured to receive standard sample plate devices, such as industry standard 96-sample well arrays 205. This can be achieved, for instance, by using electromagnets 220a-d and magnetic structure 210 formations having a geometry that corresponds with standard sample well plates. In this manner, fluidic channels and pumps are not required, reducing and even eliminating fluid processing issues relating with these elements, including, without limitation, non-specific binding and carryover (i.e., use of disposable sample plate). In addition, the use of open-well sample systems provides for more efficient methods for sample loading and collection, such as integration with an auto-sampler and other automated fluid-handling systems. In this manner, fluid processing systems according to various examples of the applicant's teachings may allow for the simultaneous processing of large arrays of samples that is simple and efficient from a fluid manipulation and a mechanical complexity perspective.

FIG. 2B depicts an example of a partial view of container comprising a layout of a plurality of sample wells 215a-d and associated magnetic structures that comprise electromagnets 220a-f that demonstrates the sharing of electromagnets 220a-f between multiple sample wells 215a-d. In this example, sample well 215d is surrounding by magnetic structure comprising electromagnets 220a, 220b, 220c, and 220d. Electromagnets 220a and 220c also surround sample well 215c that is itself also surrounded by electromagnets 220e and 220f. Electromagnets 220a and 220c can generate a magnetic field that penetrates into both sample wells 215c and 215d. Similarly, sample wells 215b and 215d share electromagnets 220a and 220b and sample wells 215a and 215c share electromagnets 220e and 220f. Electromagnet 220a is shared by sample wells 215a-d and can generate a magnetic field in all four sample wells. As should be appreciated, this structure can similarly repeat throughout the sample well plate 205 to all sample wells.

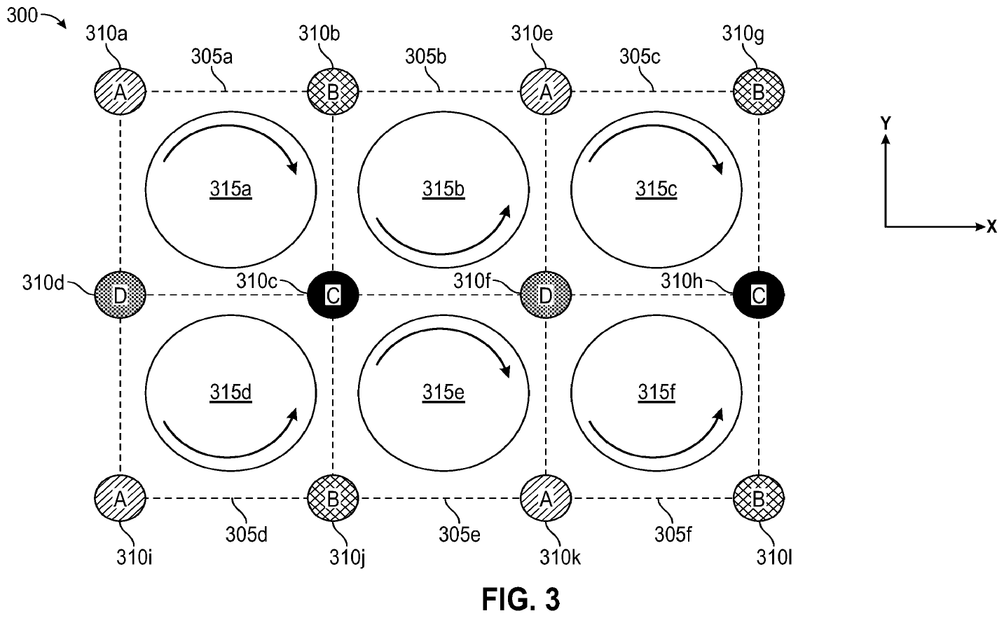

FIG. 3 schematically depicts an illustrative fluid processing system according to various aspects. As shown in FIG. 3, the fluid processing system 300 includes a plurality of magnetic structures 305a-f configured to generate a magnetic field gradient within associated fluid chambers 315a-f. Each magnetic structure 305a-f can include a plurality of electromagnets 310a-l, with certain of the electromagnets 310a-l being shared among the magnetic structures 305a-f. The electromagnets 310a-l can be controlled via the application thereto of RF signals having any suitable phase delays.

As shown in FIG. 3, the electromagnets 310a-l are labeled A-D. The phase delay of the electromagnets 310a-l of the magnetic structures 305a-f can produce a 90° phase shift for adjacent electromagnets. However, the disclosure is not so limited, as other phase shift values can be used according to various aspects of the applicant's teachings, such as a 180° phase delay, a 270° phase delay, or the like. In various aspects, the actuation of the electromagnets 310a-l according to the phase delay equations 320 causes the magnetic particles (not shown) in sample wells 315a, 315e, and 315c to mix in a clockwise motion and the magnetic particles in sample wells 315b, 315d, and 315f to mix in a counter-clockwise motion.

Mixing fluids using magnetic particles agitated according to various examples of the applicant's teachings causes the magnetic particles to be dispersed homogeneously within each fluid chamber, providing for optimal exposure and enhanced mixing with the fluid.

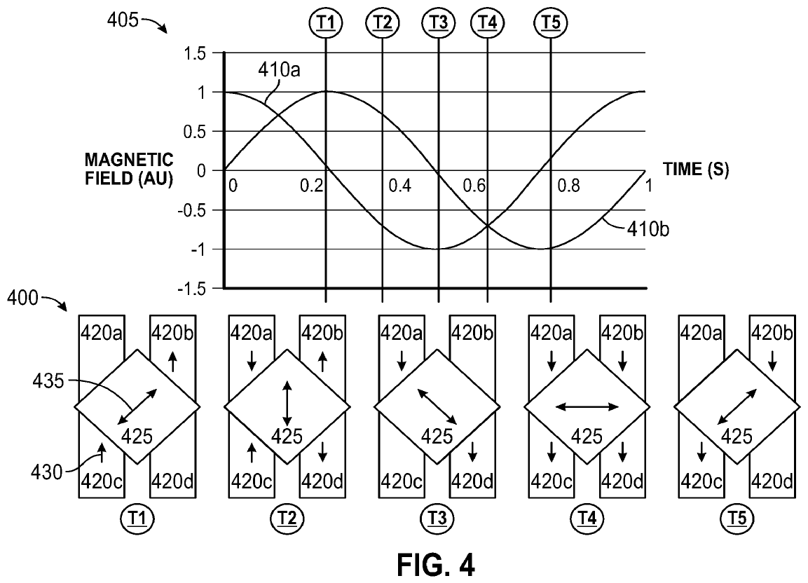

FIG. 4 depicts an illustrative fluid processing structure and mixing pattern thereof according to various examples of the applicant's teachings. The graph 405 depicts the magnetic fields 410a, 410b resulting from the application of electric current to the electromagnets 420a-d of a fluid processing structure 400 at time intervals T1-T5 according to various aspects of applicant's teachings. In various examples, the waveforms of the magnetic fields 410a, 410b represent sine waves which generate the exemplary, schematic movement 425 of the magnetic particles within the container to facilitate continuous magnetic particle mixing and improved mixing efficiency. The magnetic fields 410a, 410b have a 90° phase shift relative to one another, with the magnetic field 410a corresponding to electromagnets 420a and 420d and magnetic field 410b corresponding to electromagnets 420b and 420c. In the illustrative depiction of FIG. 4, it will be appreciated that the electromagnets 420a-d are arranged at different locations relative to the fluid sample such that the orientation of the magnetic field generated by each electromagnet generally differs when the same electrical signal is applied thereto. Likewise, because the electromagnetic pairs (i.e., 420a and 420d, and 420b and 420c) are arranged on opposed sides of the fluid sample, the magnetic field generated by the electrode in each pair is in the same direction 430 when an electrical signal of the same magnitude and of opposite phase are applied to the electromagnet in each pair. Thus, when the exemplary sinusoidal electrical signals of eq. (1)-(4) are applied to electromagnets 420a-d, respectively, the resulting magnetic field in the sample fluid will vary overtime as schematically depicted in FIG. 4, with the pair of electromagnets 420a and 420d together generating the magnetic field 410a and the pair of electromagnets 420b and 420c together generating the magnetic field 410b (magnetic field 410b is delayed 90° relative to magnetic field 410a), thereby causing the fluid to experience mixing due to the generally counter-clockwise movement 425 and alignment 435 of the particles at the various time points as schematically depicted.

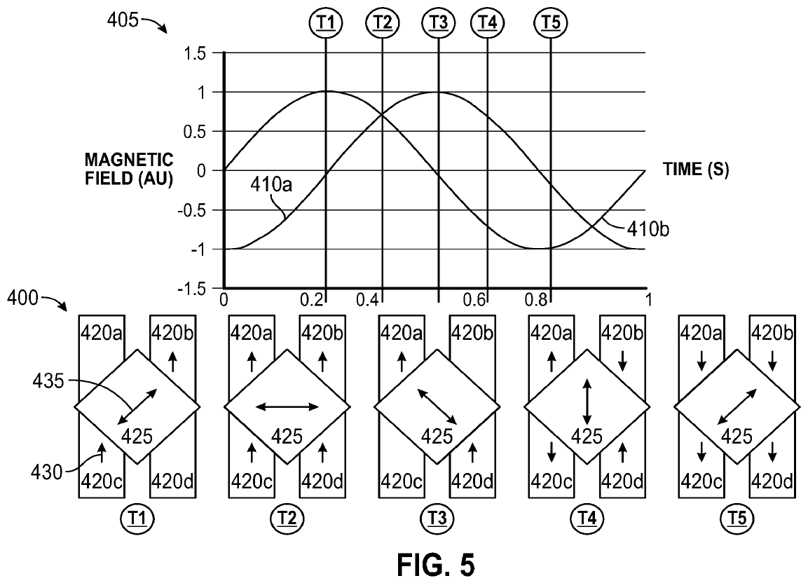

It will thus be appreciated in light of the disclosure that different mixing patterns can be effectuated by controlling the RF waveforms applied to the electromagnets of a magnetic structure. For example, with reference to FIG. 5, another illustrative mixing pattern for the fluid processing structure of FIG. 4 is depicted according to various aspects of the applicant's teachings. As shown, the fluid mixing pattern differs from that shown in FIG. 4 in that, for example, the controller is configured to apply RF signals of different phase delays to the electromagnets 420a-d.

As shown in FIG. 5, when sinusoidal electrical signals are applied to electromagnets 420a-d, respectively, the resulting magnetic field in the sample fluid will vary over time as schematically depicted, with the pair of electromagnets 420a and 420d together generating the magnetic field 410a and the pair of electromagnets 420b and 420c together generating the magnetic field 410b. In this case, the magnetic field 410a is instead delayed 90° relative to magnetic field 410b, thereby causing the fluid to be mixed in a general clockwise manner due to the movement 425 of the particles at the various time points as schematically depicted.

Although the sinusoidal RF waveforms applied to each of four electromagnets surrounding the containers of FIGS. 3-5 exhibit a ±90° shift relative to the adjacent electromagnets, the disclosure is not so limited. Indeed, it will be appreciated that any type of waveform can be supplied to electromagnets capable of operating according to applicant's teachings. By way of non-limiting example, the number of electromagnets surrounding each fluid chamber, the phase shifts between adjacent electromagnets (e.g., a 30°, 60°, 90°, 120°, 150°, 180°, 210°, 240°, 270°, 300°, and 330° phase shifts), and the waveform shape can be varied in accordance with variance aspects of the disclosure. Non-limiting examples of electrical current waveforms can include square, rectangular, triangular, asymmetrical, saw-tooth, or any combination thereof. The type of current supplied to the electromagnets can be modified during operation of a fluid processing system configured according to some embodiments. For instance, at least a portion of the electromagnets may receive an RF waveform with a 90° phase shift, while another portion may receive an RF waveform with a 180° phase shift. In such an embodiment, the phase shift of each portion can be modified during operation of the fluid processing system (e.g., the phase shifts can be switched, synchronized, or the like). At least a portion of the electromagnets can be operated in parallel, sequence, pulsed, or the like. In various aspects, the current supplied to the electromagnets can be controlled according to a processing protocol. The processing protocol can be dynamically altered during operation of the fluid processing system based on various factors, such as feedback, operator input, detection of mixing efficiency, analysis results, or the like.

In various examples, the waveform can include different segments with differing amplitudes. For example, the waveform can include an initial segment of relatively short duration with a higher amplitude (boost), followed by a lower-amplitude sustained segment. In various aspects, the amplitude of the sustained segment is below that which would excessively heat the sample. In various embodiments, the boost amplitude is higher but can be tolerated at the beginning of actuation. In various aspects, the sustained segment can be followed by a constant segment. The constant section can comprise a DC signal of constant voltage, including a voltage of zero. The combination of boost, sustained, and constant segments, or any sub-combination thereof, can be sequentially repeated. In various examples, the boost amplitude can be 1-50% higher than the sustained amplitude. In various aspects, the boost amplitude can be 10-30% higher than the sustained amplitude. In various aspects, the boost amplitude can be 20% higher than the sustained amplitude.

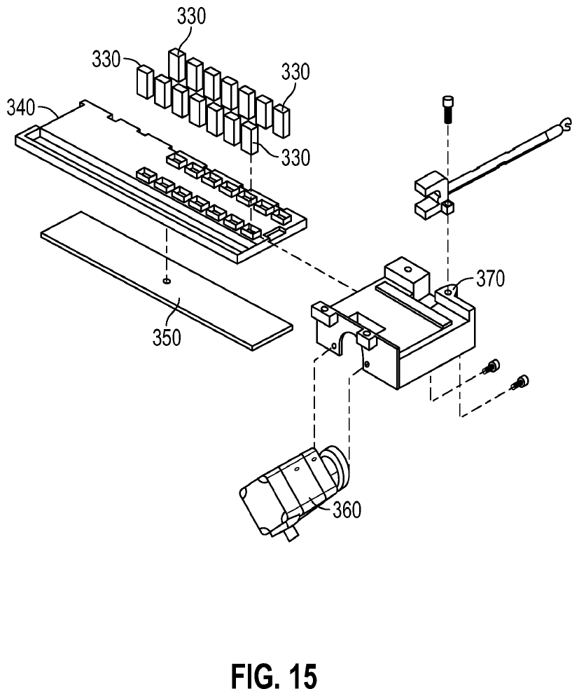

In another example, as shown in FIG. 15, vertically oriented neodymium magnets 330 are an example of a separate, permanent magnet used to draw or pull down the beads within a chamber. The magnets 330 can be used within a tray 340 or other holding mechanism. When neodymium magnets are utilized, by example, such magnets are arranged in a single row on opposing sides of at least one chamber or row of chambers. In such an example, one row of magnets 330 would be arranged such that a north pole oriented upward and in the opposing row the south pole would be oriented upward. A plate 350, by example made of steel, can be placed below the magnets 330 to connect the magnets 330 to a magnetic circuit. Further, a motor 360 can be coupled with one or both of the tray 340 and plate 350 such that when the one or both of the tray 340 and plate 350 are inserted in the guide bracket 370, the motor 360 can cause movement of the tray 340. Such movement is to a position adjacent to the chambers to pull down the beads. During mixing, the tray 340 moves the magnets 330 away from the chambers to allow the beads to remain in suspension.

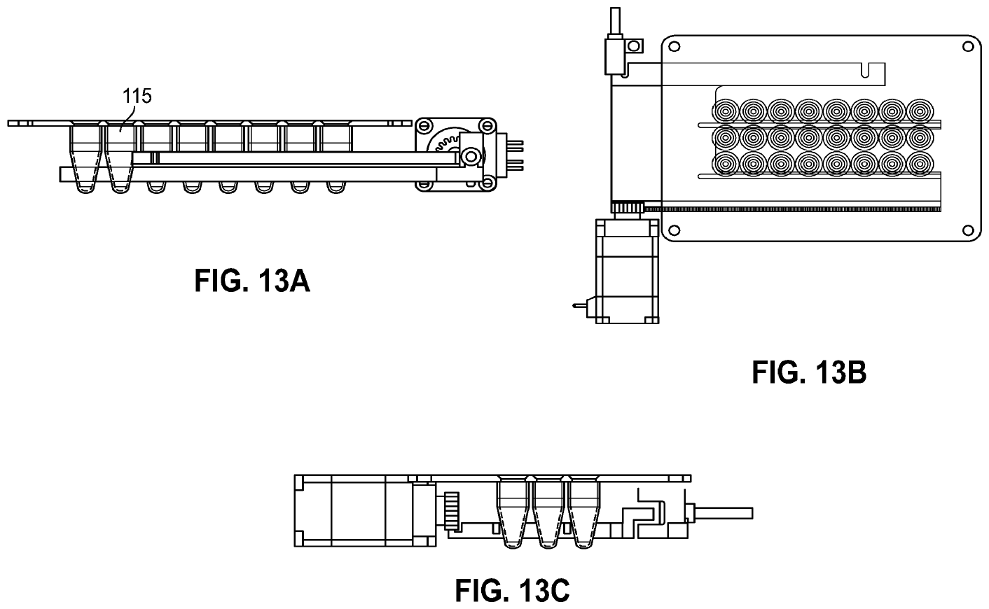

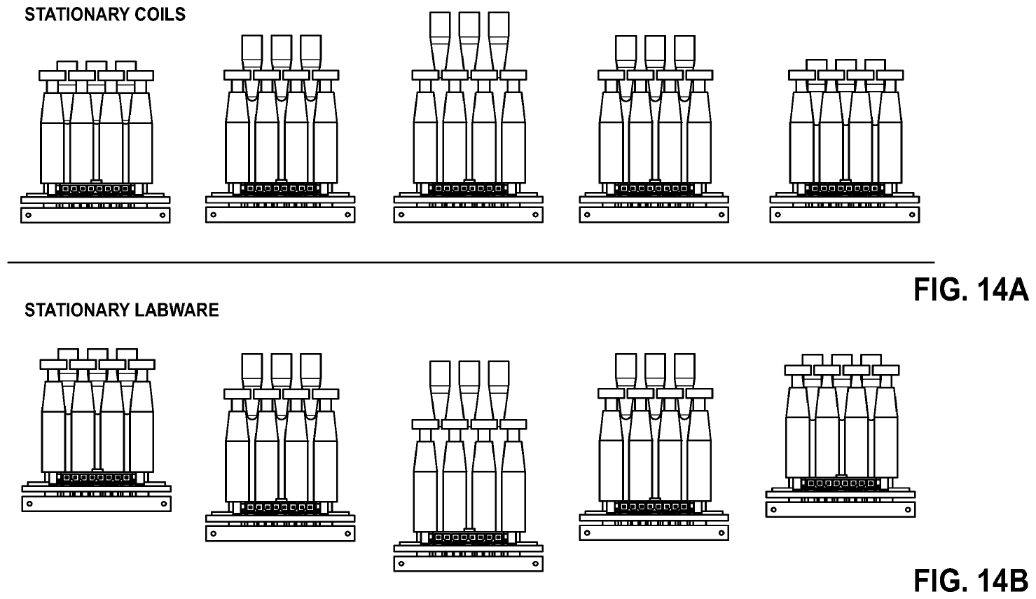

FIG. 13 is another example of the separate, permanent magnet used to pull-down beads. It is shown here in the pull-down position. The permanent magnet is the bar closest to the bottom of the tube, (the tapered, conical part, shown upside down in the current figure). In the retracted position, the tray pulls the magnetic bar away from the sample tubes. With FIG. 13B being a view from the top, FIG. 13A a view from the right, and FIG. 13C a view from the front.

Additionally, as noted herein, the electromagnets 420a-d can alternatively have a DC signal applied so as to generate a static magnetic field so as to draw magnetic particles to one side of the fluid chamber (and out of the bulk fluid) so as aid in fluid transfer from the chamber after the mixing step and/or prevent the aspiration of the magnetic particles, by way of non-limiting example. In various aspects, a separate magnet is used to draw the particles to one side of the chamber. In some examples, the separate magnet is a permanent magnet. In another example, the separate magnet is movable to be positioned immediately adjacent the container, at a desired height relative to the bottom of the container, to draw the particles. In some examples, the separate magnet can be configured to slide horizontally to the position immediately adjacent the container. In some examples, the separate magnet may have its magnetic axis aligned perpendicular to the vertical axis of the container. In another example, the separate magnet may have its magnetic axis aligned parallel with the vertical axis of the container.

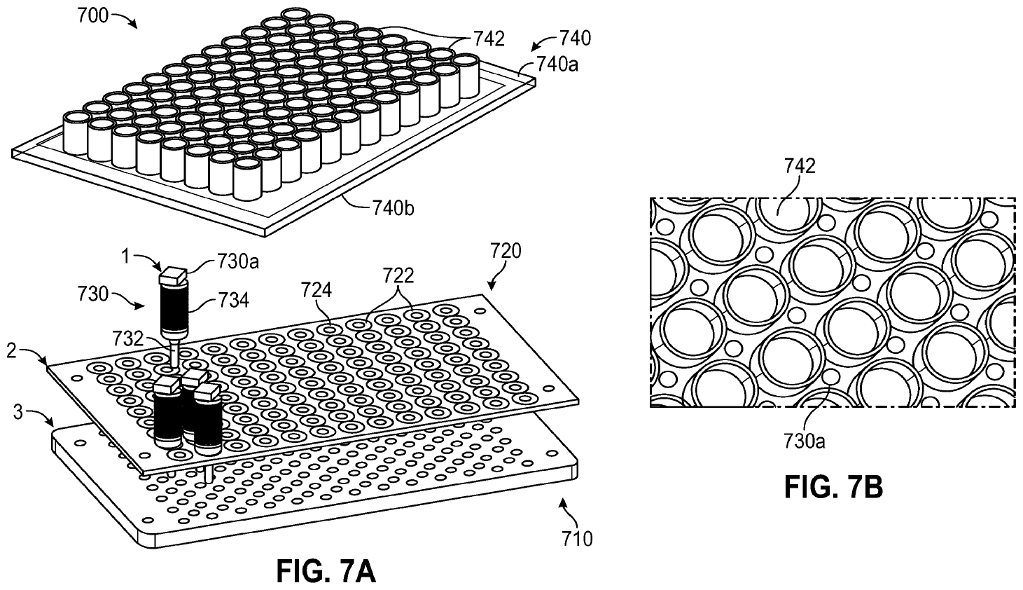

With reference now to FIGS. 7A-B, these figures provide examples of a fluid processing system 700 in accordance with various examples of the disclosure. With reference first to FIG. 7A, the fluid processing system 700, depicted in exploded view, comprises a base plate 710, a printed circuit board (PCB) 720, an plurality of electromagnetic structures 730, and an upper plate 740 defining a plurality of sample wells 740 extending from a substantially planar upper surface 740a thereof. It will be appreciated by a person skilled in the art that that though the upper plate 740 is depicted in FIG. 7A as a 96-well format in which the sample wells have a substantially circular cross-sectional shape, the upper plate 740 can include any number of sample wells 742 exhibiting a variety of cross-sectional shapes and maximum volumes as discussed above. For example, in accordance with the disclosure, each of the open sample wells 742 can be filled or partially-filled with various volumes of the fluid sample, thereby allowing for the reduction or expansion of the sample volume to be processed, depending, for example, on the availability or expense of the sample and/or on the requirements of a particular assay. It will further be appreciated that the upper plate 740 can be manufactured of any material known in the art or hereafter developed in accordance with the disclosure such as a polymeric material (e.g., polystyrene or polypropylene), all by way of non-limiting example. Additionally, as known in the art, the surfaces can be coated with a variety of surface coatings to provide increased hydrophilicty, hydrophobicity, passivation, or increased binding to cells or other analytes. In some examples, the bottom surface 740b of the upper plate 740 can be configured to engage (permanently or removably) with the lower portions of the fluid processing system, as discussed below. For example, in some aspects, the bottom surface 740b can include depressions formed therein for engaging the upper end 730a of the electromagnetic structures 730 or bores through which a portion of the electromagnetic structures can extend to be disposed around and about each of the sample wells 742.

With reference now to the lower portions of the fluid processing system 700, FIG. 7A depicts a PCB 720, a base plate 710, and a plurality of electromagnetic structures 730. As shown, the PCB 720 comprises a plurality of electrical contacts 722 to which an electrical signal can be applied by a power source (not shown) and to which the electromagnetic structures 730 can be electrically coupled. As otherwise discussed herein, the PCB 720 can be wired such that each electromagnetic structure can be individually addressed and actuated by a controller through the selective application of electrical signals thereto. Additionally, the PCB 720 includes a plurality of holes 724 through which a portion of the electromagnetic structures can extend to make electrical contact with the base plate 710. For example, as shown in FIG. 7A, the electromagnetic structures 730 can include a mounting post 732 that extends through the holes 724 when the electromagnetic structures 730 are seated on the electrical contacts 722, and such that conductive leads associated with the mounting posts 732 can be electrically coupled to the base plate 710. As shown, the base plate 710 can include bores corresponding to the mounting posts 732 so as to ensure that the mounting posts 732 are in secure engagement therewith. The base plate 710 can also be coupled to a power supply (or grounded) to complete the circuit(s) such that one or more electrical signals can be applied to the plurality of electrical contacts 722 of the PCB 720 to allow an electrical current to flow through the electromagnetic structures 730 in accordance with the disclosure. As shown in FIG. 7A, the electromagnetic structures 730 can include an upper post around which is coiled a conductive wire 734 that is electrically coupled to the contacts 722, and which terminates in an upper end 730a. It will thus be appreciated that as current flows between the electrical contacts 722, the wire coil 734, upper end 730a, and the metal base plate 710 (current direction depends on the voltage of the signal applied to the particular contacts 722 of the PCB 720), the wire coil 734 acts as a solenoid to thereby generate a magnetic field through and about the wire coil 734, the directionality of which is dependent on the direction of the current. The upper end 730a of the electromagnetic structures 730 can have a variety of shapes (e.g., substantially the same cross-section shape as the post around which the wire is coiled), though it has been found that the upper end 730a can be preferentially formed from a conductive material and shaped to correspond to the peripheral surfaces of the sample wells, so as to act as a lens that concentrates the magnetic field and/or increases its uniformity within the sample wells. As should be appreciated, the examples embodied by FIGS. 1-5 and 7 are directed to apparatuses and methods wherein the magnetic structures are arranged about a fluid container in only a single horizontal layer. In this configuration, the generation of magnetic fields causes mixing of particles in substantially the x-y plane which describes just one aspect of the disclosure. As will be detailed further in this disclosure, such systems and methods can be modified in a manner in which additional magnetic fields are generated to cause mixing of particles in the z direction as well.

It will thus be appreciated in light of the disclosure that different mixing patterns can be effectuated by controlling the RF waveforms applied to the electromagnets of a magnetic structure.

While cylindrical members have been described above in describing the tube 115, it should be appreciated that other shapes with varying cross-sectional shapes can also be utilized include triangular, square, rectangular or any other multi-sided shape.

The magnetic assemblies and/or magnetic structures that comprise electromagnets can be placed outside of the metal tube or can be part of the metal tube itself and directly integral to metal at or near the tip.

It should be appreciated that teachings described herein can be modified and adapted to meet specified needs as can be determined by ordinary skilled persons.

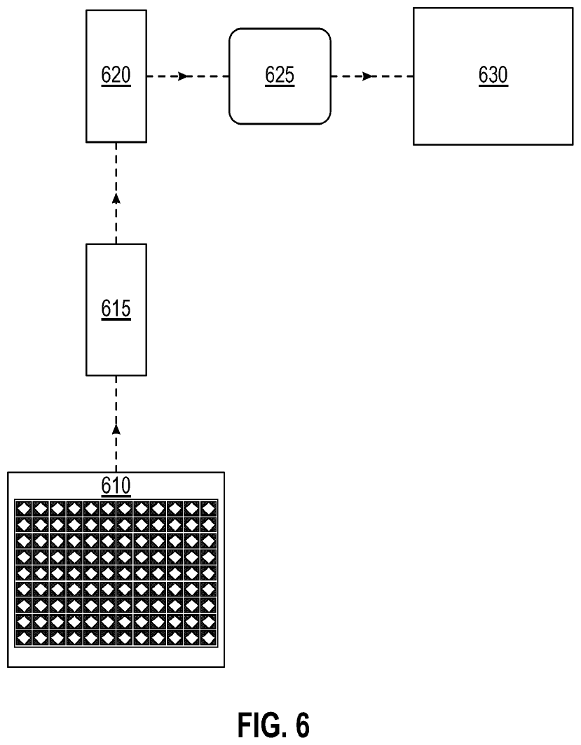

The magnetic structures and fluid processing systems described in accordance with the applicant's disclosure can be used in combination with various analysis equipment known in the art and hereafter developed and modified in accordance with the disclosure, such as an LC, CE, or MS device. With reference now to FIG. 6, one illustrative fluid processing and analysis system according to various aspects of the applicant's teachings is schematically depicted. As shown in FIG. 6, a fluid processing system 610 can be configured to process fluid samples using magnetic structures and an open-well sample plate in accordance with some embodiments. The processed fluid can be collected from the fluid processing system 610 using any of a manual sample loading device (e.g., pipette, a multi-channel pipette) or various automated systems such as a liquid handling robot, an auto-sampler, or an acoustic liquid handling device (e.g., Echo® 525 liquid handler manufactured by LabCyte, Inc. of Sunnyvale, Calif.), all by way of non-limiting example. The processed fluid can be transferred using various fluid transfer devices, such as a vortex-driven sample transfer device. As noted above, the sample removed from one sample well can be added to a different sample well on the plate for further processing steps or can be delivered to the downstream analyzer. For example, in some aspects, the processed sample can be delivered to an LC column 615 for in-line LC separation, with the eluate being delivered to the ion source 620 for ionization of the processed analytes, which can be subsequently analyzed by a DMS 625 that analyzes the ions based on their mobility through a carrier gas and/or a mass spectrometer 630 that analyzes the ions based on their m/z ratio. In some aspects, processed samples can be transferred directly to an ion source 615, with separation being provided by a differential mobility spectrometer (DMS) assembly, for example, in-line with a MS as described in U.S. Pat. No. 8,217,344. Fluid processing systems described in accordance with the applicant's disclosure in combination with a DMS assembly for chemical separation may eliminate the need for a LC (or HPLC) column for processing samples for MS analysis. In various aspects, processed samples can be introduced into analytical equipment, such as an MS, using a surface acoustic wave nebulization (SAWN) apparatus, an electrospray ionization (ESI) device, and a matrix assisted inlet ionization (MAII) source.

It will be appreciated that various of the above-disclosed and other features and functions, or alternatives thereof, can be desirably combined into many other different systems or applications. It will also be appreciated that various presently unforeseen or unanticipated alternatives, modifications, variations or improvements therein can be subsequently made by those skilled in the art which alternatives, variations and improvements are also intended to be encompassed by the following claims.

What is claimed is:

1. A method for processing fluids, comprising:
providing at least one fluid container having a fluid chamber containing a fluid and a plurality of magnetic particles;
disposing the at least one fluid container onto a magnetic assembly, the magnetic assembly including a plurality of electromagnets located about the periphery of the fluid chamber, each of the plurality of electromagnets having:
(i) an electrically-conductive coil located about a centerline that extends in a z-direction, and
(ii) a magnetic lens configured and arranged to direct a magnetic field generated by the conductive coil towards the fluid chamber,
wherein at least one of the magnetic lens or the fluid chamber is movable in the z-direction;
providing an electrical signal to each of the plurality of electromagnets so as to generate a magnetic field within the fluid chamber, wherein the magnetic field is configured to influence the plurality of magnetic particles; and
adjusting the electrical signal to modify the magnetic field within the fluid chamber while moving the at least one of the magnetic lens or the fluid chamber in the z-direction to further modify the magnetic field within the fluid chamber.

2. The method of claim 1, wherein the at least one fluid container comprises a plurality of fluidically-isolated fluid chambers, wherein at least one of the plurality of electromagnets is configured to generate the magnetic field within two or more of the plurality of fluid chambers.

3. The method of claim 1, wherein the at least one fluid container comprises a plurality of sample wells arranged within a sample plate.

4. The method of claim 3, wherein the magnetic assembly is configured to simultaneously influence the magnetic particles arranged within the plurality of sample wells.

5. The method of claim 3, wherein the sample plate comprises a bottom surface configured to removably engage at least a portion of the magnetic assembly.

6. The method of claim 1, wherein adjusting the electrical signal to modify the magnetic field within the fluid chamber comprises applying at least one electro-frequency waveform to each of the plurality of electromagnets.

7. The method of claim 6, wherein the at least one electro-frequency waveform applied to each of the plurality of electromagnets has a phase delay.

8. The method of claim 1, wherein the fluid chamber is configured to hold a maximum volume in a range of about 1 μL to about 15 mL.

9. The method of claim 1, wherein the plurality of electromagnets are arranged around the at least one fluid chamber at a plurality of vertical positions.

10. The method of claim 1, wherein the magnetic lens is moved while adjusting the electrical signal to the coils.

11. The method of claim 1, further comprising adding fluid to, mixing fluid in, removing fluid from, or heating fluid in, the fluid chamber.

12. The method of claim 1, further comprising removing the magnetic particles from the fluid.

13. A fluid processing system, comprising:
at least one fluid container defining a fluid chamber therein for containing a fluid and a plurality of magnetic particles;
a magnetic assembly including a plurality of electromagnets disposed about the periphery of the at least one fluid chamber, each of the plurality of electromagnets having:
an electrically-conductive coil located about a centerline that extends in a z-direction, and
(ii) a magnetic lens configured and arranged to direct a magnetic field generated by the conductive coil towards the fluid chamber,
wherein at least one of the magnetic lens or the fluid chamber is movable in the z-direction; and
a control component coupled to the magnetic assembly, the control component configured to:
(i) control the magnetic field generated by each of the plurality of electromagnets to generate a plurality of magnetic field gradients within the fluid chamber sufficient to magnetically influence the plurality of magnetic particles within the fluid chamber, and
(ii) control the movement of the at least one of the magnetic lens or the fluid chamber in the z-direction while generating the plurality of magnetic field gradients within the fluid chamber.

14. The system of claim 13, wherein the control component is configured to move the magnetic lens relative to the electrically-conductive coil.

15. The system of claim 13, wherein the magnetic particles are paramagnetic or ferrimagnetic.

16. The system of claim 13, further comprising a permanent magnet to generate a magnetic field within the at least one fluid chamber to draw the magnetic particles to an inside surface of the fluid chamber.

17. The system of claim 16, further comprising at least one mechanical means to move the magnetic assembly to a position adjacent to the fluid chamber.

18. The system of claim 16, wherein the magnetic assembly has at least one of the plurality of electromagnets having a magnetic axis oriented in the z-direction.

19. The system of claim 13, wherein the control component is configured to control the magnetic field generated by each of the plurality of electromagnets via applying at least one electro frequency waveform to each of the plurality of electromagnets.

20. The system of claim 19, wherein the electro frequency waveform comprises an alternating waveform and a constant waveform.
